(19) United States
(12) Patent Application Publication
(10) Pub. No.: US 2005/0240525 A1
(43) Pub. Date: Oct. 27, 2005

(54) System and method for product attribute comparison

(76) Inventor: Rajesh Arjun Bagayatkar, Fremont, CA (US)

Correspondence Address: BAY AREA INTELLECTUAL PROPERTY GROUP, LLC, PO BOX 210459, SAN FRANCISCO, CA, 94121-0459, US

(21) Appl. No.: 11/111,195

(22) Filed: Apr. 21, 2005

Related U.S. Application Data
(60) Provisional application No. 60/564,701, filed on Apr. 22, 2004.

(51) Int. Cl. G06F 17/60

(52) U.S. Cl. 705/40

(57) ABSTRACT

Product attribute comparison after a product is purchased is provided. In an embodiment, relevant product attribute(s) (e.g., product purchase price) are received from a purchase receipt, which are compared against the current value of the attribute offered by the seller, wherein if a desirable attribute change has occurred (e.g., the price for the same or similar product has dropped) the buyer is alerted. Some embodiments further automatically effecting a refund to the buyer when the desirable attribute change was detected.

### CROSS-REFERENCE TO RELATED APPLICATIONS

The present Utility patent application claims priority benefit of the U.S. provisional application for patent No. 60/564701, filed on Apr. 22, 2004 under 35 U.S.C. 119(e).

### FIELD OF THE INVENTION

The present invention relates generally to product attribute comparison. More particularly, the invention relates to systems and methods of comparing an attribute of a product, with an attribute of, a same or functionally equivalent product or a user selected product, at different point in time to, thereby, generate products and services for buyers, sellers, third party vendors, and interested fourth parties.

### BACKGROUND OF THE INVENTION

Currently, when a consumer makes a purchase the record and details of that purchase are dispersed over many decentralized databases. That is, currently, there is no single (one-stop) location to access of all the purchase records related to a consumer purchase. The decentralized nature of purchase related information makes it relatively difficult to search for a better deal (e.g., a better price for the same product or a better product for same purchase price).

Conventional approaches do not compare attributes of purchase to enable the consumer to, for example, lower product cost, or get a better product. Some known attempts at price/product comparison during the return period of a purchase focus on promoting a “department store card” by automatically refunding any price differences that arise after purchases, which could expand to other credit cards. Unfortunately, such approaches typically offer only one use, only compares price from the same store, compare only price not preferred brands or better product for same price, and only apply to credit card transactions, and, thereby, fail to capture cash/check/gift cards/etc. transactions. Moreover, such conventional approaches benefit only buyers, and not sellers or third parties (e.g., insurance, data providers, etc.).

In view of the foregoing, techniques are therefore needed to enable consumer to conveniently compare purchase attributes to lower purchasing costs or improve that value of their purchase. It would be further desirable if sellers and service providers were provided additional revenue streams as well.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system architectural and process flow diagram for attribute comparison, in accordance with an embodiment of the present invention;

FIG. 2 illustrates an exemplary system architectural and process flow diagram for an attribute comparison service as offered by a seller, in accordance with an alternative embodiment of the present invention;

FIG. 3 illustrates an exemplary system architectural block diagram for carrying out attribute comparison services, in accordance with an embodiment of the present invention:

FIG. 4 illustrates an exemplary product attribute tracking report (purchase portfolio) that Service provider may provide to the buyer, in accordance with an embodiment of the present invention; and

FIG. 5 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of product attribute comparison techniques are described.

A system for product attribute comparison after a product is purchased is provided. The transaction is between at least one seller and a buyer, wherein the seller generating a receipt documenting that the product was purchased by the buyer from the seller. In an embodiment of the present invention, a system, method, and software product are provided that include the capabilities of receiving at least one relevant product attribute from the purchase receipt, comparing the at least one received product attribute against the current value of the attribute offered by the at least one seller and detecting if a desirable attribute change has occurred, and alerting the buyer if the desirable attribute change was detected.

Some embodiments further comprise the capability of automatically effecting a refund to the buyer if said desirable attribute change was detected.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

One aspect of the present invention creates value to consumers involved in a transaction by the comparing product/service attributes, or properties, of a purchase transaction. Typical product/service attributes includes any factor relevant to the consumer's purchasing decision, which includes, but is not limited to, price, product, availability, date, return policy, low price guarantee from retailer, etc.

For example, in the case of tangible products, cost could be lowered by using comparing a “low price guarantee clause” across vendors (available in the vendor's terms of purchase), whereby, the consumer could be enabled to get a better product for same price while still during the return policy period (e.g., refund period, during service contract duration, or at end of contract duration for cell phones) of a purchase recently made.

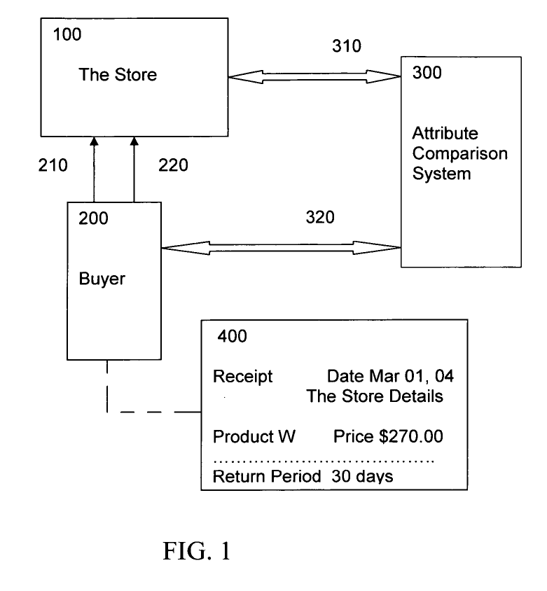

FIG. 1 illustrates an exemplary system architectural and process flow diagram for attribute comparison, in accordance with an embodiment of the present invention. The system of the present embodiment is comprised of a Store 100 (e.g., a product and/or service vendor or seller), a buyer 200 who first visits store 100 to make an initial purchase 210, and then revisits store 100 for a 2^{nd} transaction 220. The system further comprises an Attribute Comparison System 300 that has a communication path 310 with store 100 to periodically check on product/service attributes, and a path of communication 320 with Buyer 200. An exemplary receipt of purchase 400 is also shown in the Figure, which receipt is held by buyer 200. Receipt 400 may be in electronic or hardcopy form. In some alternate embodiments, and receipt may be provided to Attribute Comparison System 300 directly by the seller instead of the buyer.

In the present embodiment, the process begins by buyer 200 going to store 100 (e.g., a consumer going into a shopping mall and purchases a product W for 270.00 as shown by way of example on receipt 400). Buyer 200 is aware of Attribute Comparison System 300, by way of example, and not limitation, a third party service provider could offer the consumer service based on the Attribute Comparison System of the present invention. Buyer 200 then registers the purchase and/or places an order with Attribute Comparison System 300. By way of example, and not limitation, the step of registering an order may include paying a fee, providing receipt 400. In some embodiments of the present invention a fee may be charged to buyer 200 for registering his or her purchase to receive the services described below. In some alternate embodiments of the present invention, no fee is charged to buyer 200, and revenues are generated by other means including, but not limited to, fourth party advertisers.

The Attribute Comparison System 300 then accepts the order and records relevant information from the receipt 400. Relevant information may include, for example, store name, location in the mall, product details, purchase date, price paid, return period, buyers contact information, or any other purchase related information that may be helpful for attribute comparison in accordance with the teachings of the present invention. Receipt 400 may be in machine readable formats (e.g., without limitation, ASCII text, HTML, etc.) whereby Attribute Comparison System 300 would extract the pertinent information. In some embodiments, if receipt 400 is a physical, non-electronic receipt, buyer 200 could scan the receipt into an image format, which Attribute Comparison System 300 converts into a machine readable format by way of known optical character recognition (OCR) techniques. In alternate embodiments of the present invention, buyer 200 is prompted to enter relevant purchasing information into Attribute Comparison System 300 by way of a graphical user interface (GUI) (not shown).

Over some period of time as needed or requested, the Attribute Comparison System 300 then searches for relevant products that buyer 200 may be interested in, in the context of receipt 400. By way of example, and not limitation, Attribute Comparison System 300 may find on the 20th day after purchase the same product is offered at a lower price (i.e., a desirable attribute change has occurred) by the same store 100, which store has a 30 day return policy, whereby buyer 200 may wish to request a corresponding refund; similarly, Attribute Comparison System 300 may find other stores within the return policy timer period that offer a better value. Then Attribute Comparison System 300 timely communicates this opportunity to buyer 200. In some embodiments of the present invention, the buyer can set certain thresholds that the attribute (e.g., price drop) needs to change by before triggering an alert or refund event.

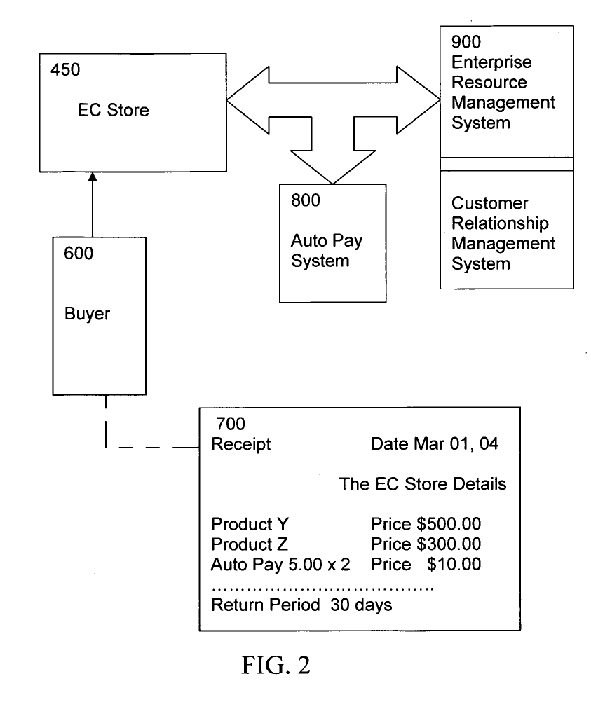

FIG. 2 illustrates an exemplary system architectural and process flow diagram for an attribute comparison service as offered by a seller, in accordance with an alternative embodiment of the present invention. The system of the present embodiment is comprised of seller with a retail chain outlet electronic commerce (EC) store 450, A buyer 600, a receipt 700, an auto pay system 800, and an enterprise resource management (ERM) system and customer relationship management (CRM) system 900. The steps in carrying out the present method embodiment will now be described in some detail. The process begins with buyer 600 first visiting EC store 450 and purchasing an exemplary “product Y” (at $500.00 for example) and an exemplary “product Z” (at $300.00 for example) as shown, by way of example, on exemplary receipt 700. Around the time of purchase, buyer 600 is made offered an optional an automatic price difference payment service (i.e., an “auto pay” price reduction protection plan, which is enabled by auto pay system 800) by EC store 450, wherein if the price of a purchased product drops below the buyer's purchase price during a certain return period the difference is refunded. Buyer 600 then orders the automatic service for the products where such protection is desired. In the preferred embodiment, buyer 600 would pay a per product fee for the price reduction protection plan; by way of example, and not limitation, a $5.00 fee per item, or a total of $10 as shown in example receipt 700. EC store 450 then collects buyer contact information to communicate when any automatic payment.

EC store 450 has access to Auto pay system 800, which implements the teachings of the present invention and compares customer purchase with current store price to determine price drops. In some embodiments, Auto pay system 800 may be integrated with an enterprise resource management system and customer relationship management system 900, which is typically part of an EC store's infrastructure.

For example, if during the return period, 30 days from purchase in the present example, only product Y price dropped by 30.00 and the product Z price remained same, then after 31 days from purchase EC store 450 would communicate this status to buyer 600, and generate an automatic refund of 30.00 to the buyer's credit card. In this example EC store 450 made extra revenue of 10.00 by selling the optional service and buyer 600 saved 30.00 on product Y without have to visit the store. In non-credit card purchasing transactions, refunds may be made by check.

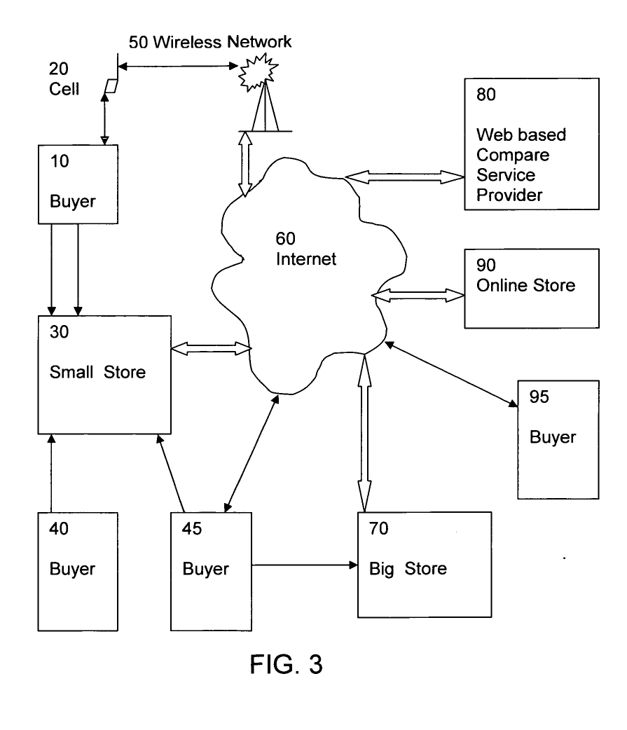

FIG. 3 illustrates an exemplary system architectural block diagram for carrying out web-based attribute comparison services, in accordance with another embodiment of the present invention. The Figures shows, by way of example, and not limitation, how many typical different buyer/seller situations are captured by the present invention. The system components of the present embodiment comprises a multiplicity of different Buyers 10, 40, 45, 95, a small store 30 (e.g., brick and mortar store), a big stores 70, an online store 90, a wireless network 50 and Cell phone 20, an Internet network 60, and a web based comparison service provider 80.

The internet is 60, provides network facility to buyers 10, 45, 95, all sellers 30, 70, 90, web based service provider 80, and wireless network 50. Web based compare service provider 80 implements a compare and track service embodiment based upon the teachings of the present invention. Service provider 80 provides online account to buyers 45, 95, to track their purchases using HTTP, SSL; Service provider 80 may also provide online store 90 and big store 70 web service based on advanced protocols, including XML, and SOAP. Service provider 80 may also offer small store 30 with simple web HTTP, FTP and SSL based service. Service provider 80 may also provide secure interfaces to use their facility. Service provider 80, in the present example, can communicate with Wireless Access Protocol enabled devices like cell phone 20, and can also receives periodic price data from all the stores using any suitable communication protocols; e.g., FTP and HTTP.

Small store 30 may offer its buyers a multiplicity of purchase comparing services that are carried out by service provider 80. The buyer is (automatically) contacted, by any suitable means (including automated calls and e-mails), to be alerted of any automatic price protection refunds that were made. In some embodiments of the present invention, the buyer is only notified of the price drop and, instead, must thereafter request the refund. Some stores may have periodic product pricing updates, such as only changing prices once a week.

Small store 30, preferably, exchanges data with service provider 80 periodically. For example, data exchanges includes downloading information about any refund to be paid with details and uploads new price list, purchases, returns and any other needed additional information over a, preferably, secure Internet connection using standard protocols such as HTTP, FTP and SSL.

Big store 70 and online store 90 use interfaces from service provider 80 to offer purchase tracking service and auto pay service to its customers. Buyer 10, Buyer 40 purchase only at small store 30. Cell 20 represents a cell phone used by Buyer 10 to track purchases using a wireless service (e.g., WAP-wireless access protocol) to service provider 80 and to receive any communication from small store 30. Buyer 45 buy at both small store 30 and big store 70, but tracks purchases using online account with service provider 80. Buyer 95 buys only at online store 90. The store 90 offers purchase portfolio account on its website using interfaces to service available from provider 80. Typical purchase related matters are also handled by the present purchasing management/tracking system, including, for example, shipping cost, shipping insurance, any applicable restocking fee and penalties for returning product.

The exemplary steps involved in carrying out the Web based comparison service according to the present embodiment will now be described in some detail. Initially, buyer 10 makes a purchase at small store 30, and uses WAP enabled cell phone 20 to track the price drop. Buyer 10 has option to receive notification voice call his cell phone 20. Buyer has to visits store 30 to get refund against price drop. For example, assuming buyer 40 makes a purchase at small store 30, and enrolls into the above described price protection service (auto pay service) there from, if the price of the purchased product drops, as detected by service provider 80, Buyer 40 would receive an automatic refund. Similarly, if Buyer 95 makes a purchase at online store 90, and enrolls into the above described auto pay service there from, if the price of the purchased product drops, as detected by service provider 80, Buyer 95 would receive an automatic refund.

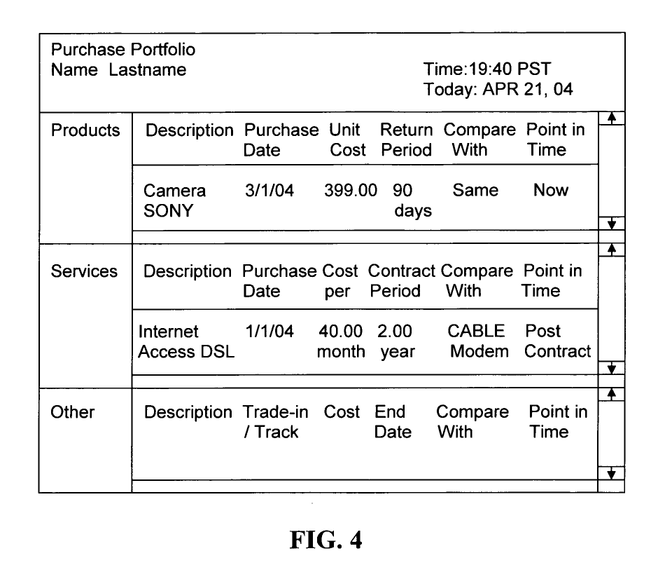

FIG. 4 illustrates an exemplary product attribute tracking report (purchase portfolio) that Service provider 80 may provide to the buyer, in accordance with an embodiment of the present invention. That is, service provider 80 can provide to the buyer a purchase portfolio service, whereby if the buyer purchases products from different vendors, an attribute comparison tracking report is provided to the buyer to assist the buy in managing his or her portfolio of products that are being tracked by service provider 80 on behalf of the buyer. By way of example, and not limitation, assuming Buyer 45 procured the purchase portfolio tracking service of the present embodiment, if he or she purchases products at both seller 30 and 70, for example, a product attribute tracking report would be generated (as exemplified in FIG. 4) and delivered to Buyer 45.

A multiplicity of alternate embodiments based on the foregoing teachings is contemplated and possible. For example, one alternate embodiment of the present invention, applies to a product or service purchased, wherein the purchase price is selected as an attribute of the comparison for the product. The other relevant information of the purchase is return period or return date on the record of purchase or bill or receipt or invoice. If the comparison between purchase price, and the current price for the same product from the same seller, shows drop in price and if the day of comparison lies within return period or earlier than return date. The buyer has opportunity to save on past purchase. An entity with access to necessary information in this embodiment can communicate to buyer about the opportunity and additionally to seller. In this embodiment other information to consider about transaction comprise of sale terms, contract terms, return policy, buyer location, seller location, delivery to buyer shipping cost, restocking fee, shipping insurance costs, handling cost, return shipping cost, other costs; to determine possibility of benefit to purchaser.

In yet another embodiment of the present invention, to track trade-in offers for a special product, for example a product used for video editing acquired about a year ago, which cannot be returned or exchanged any! longer. The two attributes selected for comparison are price and a feature called encoding. The different time points chosen for comparison are, one fixed point yesterday's date and another one is now, which changes every today. By way of example, and not limitation, if a buyer wants to check any offers available in next 2 months only, then the duration of comparison is selected as two months, wherein during in next two months, the buyer will be alerted of any offers, by the system.

In another embodiment of the present invention, the seller offers different variations of services based upon the present invention at point of sale to buyer. For example, for small fee basic service, seller will notify buyer, in the event of price drop of purchased product, that occur within standard return period. For an extra fee, an advanced service may be procured, wherein, for example, the seller may offer extended price comparison period or comparison with competitor's promotions, with option of automatic benefit or refund payment to buyer.

In still another embodiment of the present invention, the third party can derive direct or indirect benefit by offering this system, part of this system, information accumulated over electronic media, physical media, storage media, communication networks, network of devices, in the form of software product, software add-on to enterprise resource management applications, paid service, subscription, free to members, interface to web service, broadcast, access to system. Third party also derive benefit from free service with indirect revenue of advertisement, relevant product selling, sponsorship, donations, selling available information to fourth parties like potential buyers, market researcher, manufacturer, distributors.

In yet another embodiment of the present invention, services or business methods based upon the teachings of the present invention are offered as business franchise in the areas where local, physical, stores sell more products than retail chain stores or local stores sell special products. This franchise can help ensure buyers are getting the opportunity to save on purchased products by periodically obtaining new prices from local stores. Since physical proximity with local store is key in this case, the present embodiment will enable the present invention to offer value to the buyer and seller as franchise business.

In another embodiment of the present invention, a TV show is produced which will compare price changes of popular items (e.g., recent electronics), and also gather information from the viewers about their recent purchases, during, before or after show and include them in the next episode in addition to popular products.

In yet another embodiment of the present invention, selection is offered of at least one attribute for a product, compared with a similar attribute of functionally equivalent product at later point in time. For example, price comparison of camera and camcorder, wherein the trade off chosen by the user is price range and purchase priority. Buyer has top priority for camcorder but purchases camera due to budget constraint. Using this system compares camera purchase price with camcorder price till return date. If camcorder price drops for a short period of couple of days, this method identifies opportunity to buy top priority item and return low priority item.

In still another embodiment of the present invention, selection is offered of at least one attribute for a product, from a list comprised of model, product identification, price, feature, contract term, seller-location, buyer location, sale term, return period, return date, subscription duration, or lease term, which is to be compared with any user selected product, combined with penalty cost, restocking fee, shipping fee, insurance fee, other shipping expenses, return date, return date, contract length

In another embodiment of the present invention, the comparison time can be selected, which allows comparison of attribute data taken at two different times separated by any practical period; for example, between a fraction of second to several years. The user can also choose comparison between attribute data for specific fixed point in time and a variable point in time. One example is comparison between purchase price on purchase date in the past and today's price. Other example is product price fluctuation in any three months for last year.

In another alternative embodiment of the present invention, an organization periodically compares past purchases with current offerings. This allows the organization to renegotiate of price and contract terms for past and future purchases, with its vendors. The present method creates valuable information which can save money for buyer and opportunity for seller to retain customer, as well as sell additional products (service like warranty/automatic_price_match, related products)

As set forth by way of several exemplary embodiments above, it is clear that embodiments of the present invention can save buyers money on the purchase already made while also benefits sellers and third parties (e.g., service providers such as insurance companies, online data providers, etc.). In this way, one aspect of the present invention is to provide sellers an additional product offering of a “price drop insurance”, which is akin (as a service model) to popular extended warrantees. For example, Insurance companies can sell insurance to retailers to protect against price drops due to competition (i.e., competitive brands or other retailers), wherein the price drops are monitored and reported according to the teachings of the present invention.

Embodiments of the present invention are well suited to be integrated into ERM and/or CRM software made by companies like Oracle/Microsoft. Moreover, online service providers like Yahoo and Google may also implement services based on the foregoing teaching to, thereby, attract additional online visitors and generate more advertising revenue. Retailers like BestBuy, Amazon will also find embodiments of the present invention very helpful for customer loyalty and retention.

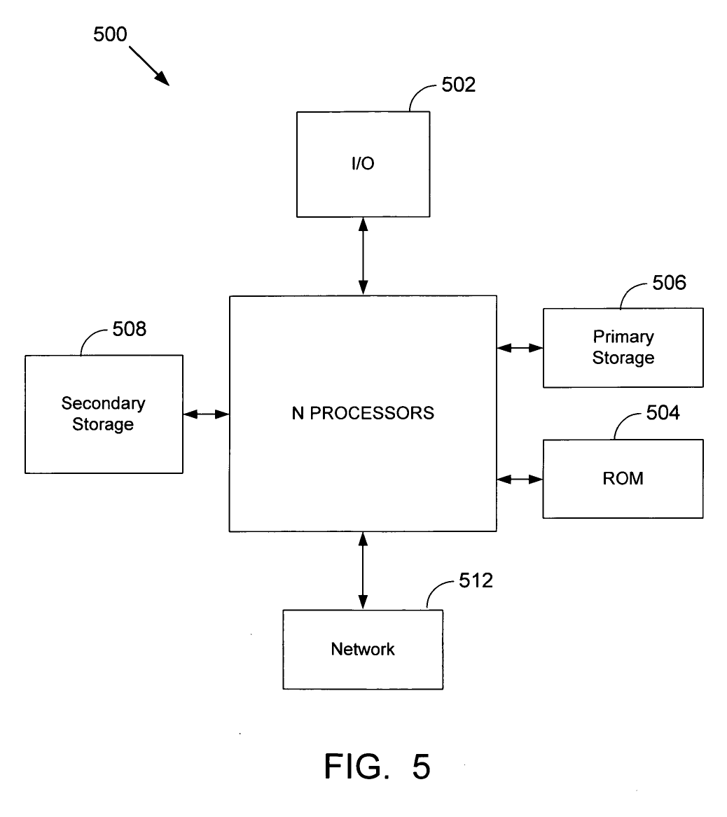

FIG. 5 illustrates a typical computer system that, when appropriately configured or designed, can serve as a computer system in which the invention may be embodied. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers and microprocessors such as programmable devices (e.g., CPLDs and FPGAs) and unprogrammable devices such as gate array ASICs or general purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described above. A mass storage device 508 may also be coupled bi-directionally to CPU 502 and provides additional data storage capacity and may include any of the computer-readable media described above. Mass storage device 508 may be used to store programs, data and the like and is typically a secondary storage medium such as a hard disk. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 may also be coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications or internet network using an external connection as shown generally at 512. With such a connection, it is contemplated that the CPU might receive information from the network, or might output information to the network in the course of performing the method steps described in the teachings of the present invention.

Having fully described at least one embodiment of the present invention, other equivalent or alternative methods of product attribute comparison according to the present invention will be apparent to those skilled in the art. The invention has been described above by way of illustration, and the specific embodiments disclosed are not intended to limit the invention to the particular forms disclosed. For example, the product attributes described in the foregoing example were principally directed to price based implementations; however, similar techniques apply to any product attribute of interest to the buyer, which alternative implementations of the present invention are contemplated as within the scope of the present invention. The invention is thus to cover all modifications, equivalents, and alternatives falling within the spirit and scope of the following claims.

1. A system for product attribute comparison related to a product purchase transaction between at least one seller and a buyer, the seller generating a receipt documenting that the product was purchased by the buyer from the seller, the system comprising:
means for receiving at least one relevant product attribute from the purchase receipt;
means for comparing said at least one received product attribute against the current value of the attribute offered by the at least one seller and detecting if a desirable attribute change has occurred; and
means for alerting the buyer if said desirable attribute change was detected.

2. The product attribute comparison system of claim 1 further comprising means for automatically effecting a refund to the buyer if said desirable attribute change was detected.

3. The product attribute comparison system of claim 1 further comprising:
means for generating a product attribute tracking report; and
means for delivering said product attribute tracking report to the buyer.

4. The product attribute comparison system of claim 1 further comprising means for tracking a product trade-in offer by the seller.

5. The product attribute comparison system of claim 1, wherein said desirable attribute change was detected during a product return period specified by the seller.

6. The product attribute comparison system of claim 1 further comprising means for receiving from the buyer an indication of which of said at least one product attributes said comparing means will use as a basis for comparison.

7. The product attribute comparison system of claim 1 wherein said comparing means compares said at least one product attribute with a similar product attribute of functionally equivalent product.

8. A method for product attribute comparison related to a product purchase transaction between at least one seller and a buyer, the seller generating a receipt documenting that the product was purchased by the buyer from the seller, the method comprising the Steps of:
receiving at least one relevant product attribute from the purchase receipt;
comparing said at least one received product attribute against the current value of the attribute offered by the at least one seller and detecting if a desirable attribute change has occurred; and
alerting the buyer if said desirable attribute change was detected.

9. The product attribute comparison method of claim 8 further comprising the Step of automatically effecting a refund to the buyer if said desirable attribute change was detected.

10. The product attribute comparison method of claim 8 further comprising the Steps of:
generating a product attribute tracking report; and
delivering said product attribute tracking report to the buyer.

11. The product attribute comparison method of claim 8 further comprising the Step of tracking a product trade-in offer by the seller.

12. The product attribute comparison method of claim 8, wherein the Step of alerting occurs when the desirable attribute change was detected during a product return period specified by the seller.

13. The product attribute comparison method of claim 8 further comprising the Step of receiving from the buyer an indication of which of said at least one product attributes will be use as a basis for comparison in the comparing Step.

14. The product attribute comparison method of claim 8 wherein the comparing Step compares said at least one product attribute with a similar product attribute of functionally equivalent product.

15. A computer program product for product attribute comparison related to a product purchase transaction between at least one seller and a buyer, the seller generating a receipt documenting that the product was purchased by the buyer from the seller, the computer program product comprising:
computer code that receives at least one relevant product attribute from the purchase receipt;
computer code that compares said at least one received product attribute against the current value of the attribute offered by the at least one seller and detecting if a desirable attribute change has occurred;
computer code that alerts the buyer if said desirable attribute change was detected; and
a computer-readable medium that stores the computer code.

16. The computer program product according to claim 15, further comprising computer code that automatically effects a refund to the buyer if said desirable attribute change was detected.

17. The computer program product according to claim 15, further comprising:
computer code that generates a product attribute tracking report; and
computer code that delivers said product attribute tracking report to the buyer.

18. The computer program product according to claim 15, further comprising computer code that tracks a product trade-in offer by the seller.

19. The computer program product according to claim 15, further comprising computer code that receives from the buyer an indication of which of said at least one product attributes said comparing means will use as a basis for comparison.

20. The computer program product according to claim 15, wherein the computer-readable medium is one selected from the group consisting of a data signal embodied in a carrier wave, a CD-ROM, a hard disk, a floppy disk, a tape drive, and semiconductor memory
